(19) United States
(12) Patent Application Publication
(10) Pub. No.: US 2006/0129350 A1
(43) Pub. Date: Jun. 15, 2006

(54) Biphase vernier time code generator

(76) Inventor: Burnell G. West, Half Moon Bay, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/012,555

(22) Filed: Dec. 14, 2004

(51) Int. Cl. G04F 10/00

(52) U.S. Cl. 702/176

(57) ABSTRACT

A time code generator for generating a digital value associated with the arrival time of an event, such as a logical transition of a digital signal. In one embodiment, the time code generator includes a pair of oscillators configured to generate a plurality of oscillating signals of differing phases relative to the system clock. A first and second phase counters are each driven by one of the plurality of oscillating signals. Each of the oscillating signals drives a separate vernier interpolator configured to capture an event. A composite time coder is in communication with the phase counters and the plurality of vernier interpolators to generate a digital value indicating the arrival time of the event.

### FIELD OF THE INVENTION

Aspects of the invention relate generally to electronic circuits and methods indicating the time of an event arrival. More specifically, aspects of the invention involve electronic circuits and methods of generating a digital value indicating the time of an event arrival denoted by a logic signal.

### BACKGROUND

The accurate and precise recording of the arrival time of an event, such as the transition of a logic signal from one logic level to another, is beneficial in many electronics applications where signal measurement is an important task. For example, various forms of automatic test equipment (“ATE”) measure the performance of a device under test, such as an integrated circuit (“IC”). One common test involves measuring the time at which a logic signal transitions at the output signal line of an IC in response to a change in device input. Such a test is typically used to characterize the operational speed of the IC.

Given a progressive decrease in logic gate delays as IC technology advances, as well as the increased timing constraints under which such ICs operate, capturing the arrival time of an event at a sufficient resolution to provide worthwhile information regarding the performance of the IC becomes increasingly difficult. Oftentimes, the resolution required in determining an event arrival time exceeds the resolution of the fastest system clock available in the ATE system analyzing the IC, making the task even more ominous.

In addition, since such events typically arrive asynchronously to the clock domain of a system utilizing the event timing information, properly transferring the timing information from the event time domain to the system clock time domain is important. Such asynchronous behavior may cause misinterpretation of the event arrival time, and in some cases may even cause metastability in the circuit determining the arrival time of the event of interest.

Given the foregoing, circuits and methods that provide accurate, high-resolution digital coding of the arrival time of an event would be advantageous.

### SUMMARY OF THE INVENTION

Generally, embodiments of the present invention provide a time code generator and associated method for generating a digital value indicating an arrival time of an event. A first oscillator is used to generate a plurality of first oscillating signals during each positive phase of a system clock, and a second oscillator is employed to generate a plurality of second oscillating signals during each negative phase of the system clock. Each of the oscillating signals is of a different phase relative to the system clock. A first phase counter is driven by one of the first oscillating signals, and a second phase counter is driven by one of the second oscillating signals. Each of the first and second phase counters counts the number of oscillations of the oscillating signals in a phase of the system clock. Each of the oscillating signals drives a vernier interpolator, at least one of which captures an event. A composite time coder is in communication with the phase counters and the vernier interpolators to generate a digital value indicating the arrival time of the event.

In one embodiment of the invention, the digital value, or timestamp, of an event arrival is produced using a state of a vernier interpolator capturing the event, the identity of the vernier interpolator capturing the event, the value of the phase counter associated with the vernier interpolator capturing the event, and the system clock phase associated with the vernier interpolator capturing the event.

In another embodiment, a method for generating a digital value indicating an arrival time of an event includes generating a plurality of oscillating signals by way of a system clock, wherein each of the oscillating signals oscillates faster than the system clock. Also, each oscillating signal is initiated at a different phase within each period of the system clock. An event is captured to produce a logical state indicating the time of the event relative to a particular oscillation of one of the oscillating signals. The digital value is then composed which indicates the time of the event within a period of the system clock by way of the logical state from the capturing step, the identity of the oscillating signal related to the event, and the identity of the particular oscillation of the related oscillation signal.

Additional embodiments and advantages of the invention will be realized by those skilled in the art upon reading the detailed description of the invention, presented below.

### BRIEF DESCRIPTION OF THE DRAWINGS

FIG. 1 depicts a schematic diagram of a time code generator according to an embodiment of the invention.

FIG. 2 depicts a timing diagram of a positive phase section and a negative phase section of the time code generator of FIG. 1.

FIG. 3 depicts a vernier interpolator of the time code generator of FIG. 1.

FIG. 4 depicts an emitter-follower circuit of the vernier interpolator of FIG. 3.

FIG. 5A depicts a timing diagram of the operation of the vernier interpolator of FIG. 3 when capturing a typical event arrival.

FIG. 5B depicts a timing diagram of the operation of the vernier interpolator of FIG. 3 when capturing an event arrival of slightly different timing from that shown in FIG. 5A.

FIG. 6 depicts a timing diagram of the operation of the time code generator of FIG. 1, incorporating the timing of the vernier interpolators in the capturing of an event arrival.

FIG. 7 depicts the fields of a timestamp generated by the time code generator of FIG. 1.

FIG. 8 depicts a system clock domain synchronizing circuit employable by the time code generator of FIG. 1 according to an embodiment of the invention.

FIG. 9A depicts a timing diagram of the operation of the system clock domain synchronizing circuit of FIG. 8 when an event arrives just prior to a rising edge of the system clock.

FIG. 9B depicts a timing diagram of the operation of the system clock domain synchronizing circuit of FIG. 8 when an event arrives just after a rising edge of the system clock.

### DETAILED DESCRIPTION OF EMBODIMENTS OF THE INVENTION

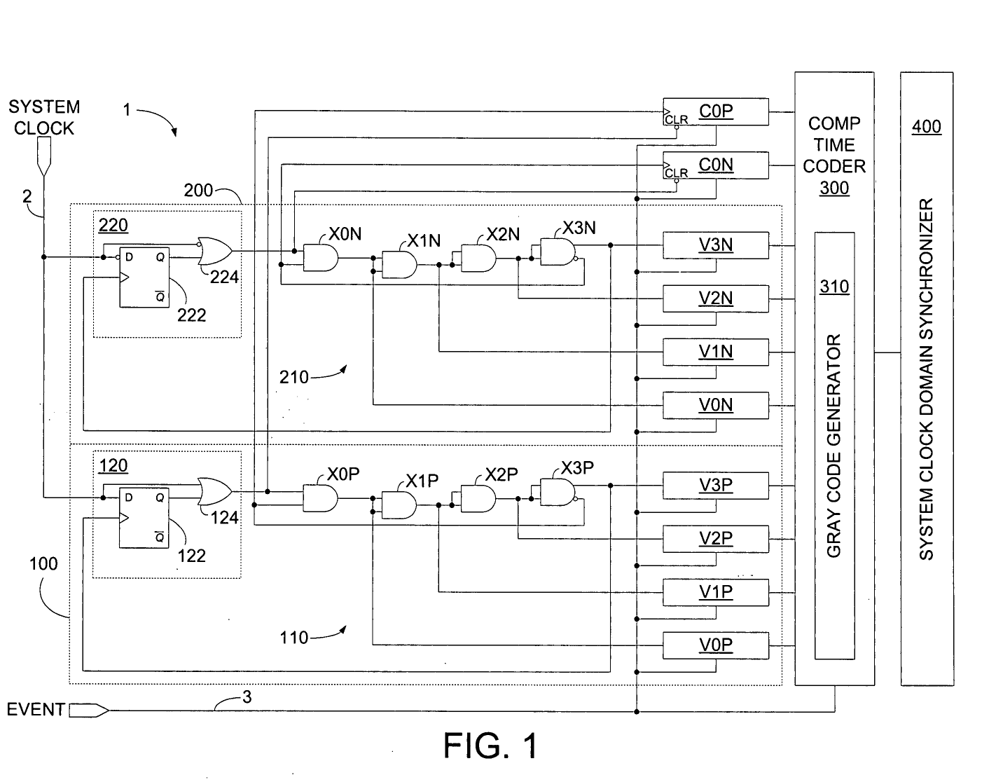

One embodiment of the invention, a biphase vernier time code generator 1, is illustrated at a high level in FIG. 1. Generally, the time code generator 1 is primarily a digital electronic circuit employed for “timestamping” an event. In other words, the circuit 1 generates a digital value indicating the time of arrival of an event at a prescribed time resolution. Typically, the time code generator 1 is coupled with other electronic circuitry residing within an electronic device designed to perform a specific task, such as automatic test equipment (“ATE”) for testing semiconductor integrated circuits (“ICs”). In the example of an ATE employing a biphase vernier time code generator, the time code generator 1 may provide timing information to the other electronic circuitry regarding signal voltage changes of an IC under test, often referred to as a device under test (“DUT”). Alternatively, the electronic device incorporating the time code generator 1 may be general-purpose electronic equipment, such as a computer or workstation, designed and programmed to perform a multitude of tasks. In other embodiments, the time code generator 1 may be physically separated to some degree from the circuitry with which it interfaces, such as residing on a separate printed circuit board, or even located within its own mechanical enclosure.

Generally, the time code generator 1 receives as input two signals: a system clock 2, which typically also drives much of the other electronic circuitry with which the time code generator 1 is coupled, and an event signal 3. The event signal 3 indicates the occurrence of an event by changing voltage levels or logic states. In the embodiments described below, an event is indicated by a LOW-to-HIGH logic level transition of the event signal 3. In alternative embodiments, HIGH-to-LOW logic level transitions may also be detected, as well as analog voltage or current level transitions, given appropriate circuitry to transform the event signal 3 into a digital form usable by the time code generator 1.

While specific embodiments of the time code generator 1 are presented and described herein, alternative embodiments of the invention are possible which are not specifically described below. For example, circuits employing varying alternative logic gates or circuits that provide similar functionality as presented herein are employable while remaining within the scope of the invention. Additionally, a time code generator may be implemented in an application specific integrated circuit (“ASIC”) or other processing platform.

As shown in FIG. 1, the time code generator 1 is divided into a positive phase section 100 (represented generally in the bottom half of FIG. 1) and a negative phase section 200 (shown generally in the top half of FIG. 1). The positive phase section 100 becomes active upon a positive (LOW-to-HIGH) transition of the system clock 2, and remains active throughout at least the time the system clock 2 remains HIGH. Similarly, the negative phase section 200 is activated when the system clock 2 transitions from HIGH to LOW, and remains active at least during the time the system clock 2 remains LOW.

Still referring to FIG. 1, each of the positive and negative phase sections 100, 200 employs a gated ring oscillator 110, 210, a phase counter C0P, C0N, and vernier interpolators V0P-V3P, V0N-V3N. The phase counters C0P, C0N and vernier interpolators V0P-V3P, V0N-V3N supply information to a composite time coder 300 (including a Gray code generator 310), which in turn may be coupled with a system clock domain synchronizer 400.

In operation, during each positive phase of the system clock 2, the gated ring oscillator 110 of the positive phase section 100 initiates an operational cycle of each associated vernier interpolator V0P-V3P in a phased, cyclical fashion so that at least one interpolator V0P-V3P is operating during the entire positive phase of the system clock 2. Each vernier interpolator V0P-V3P, operating for a limited time period upon initiation, provides a precise mechanism for generating a digital number relating to the time of an event arriving during its operation. In addition, the phase counter C0P of the positive phase section 100 counts each successive cycle of the gated ring oscillator 110 during a particular positive phase of the system clock 2. During each negative phase of the system clock 2, the components of the negative phase section 200 operate in an analogous fashion to that of the positive phase section 100. Thus, taken in the aggregate, the identity of the particular phase of the system clock 2 during which an event occurs (i.e., positive or negative), in conjunction with the value of the active phase counter C0P, C0N at the time of the event arrival, and the identity and attendant digital number of the particular vernier interpolator V0P-V3P, V0N-V3N that captured the event arrival, are employed by the composite time coder 300 to produce a digital value indicating the arrival time of each event captured by the time code generator 1. In addition, the system time domain synchronizer 400 may transfer each digital value produced by the composite time coder 300 to a circuit synchronized with the system clock 2. Each section of the time code generator 1 is described in greater detail below.

Each gated ring oscillator 110, 210 includes four logical AND gates X0P-X3P, X0N-X3N connected in a ring configuration, with the output of one AND gate driving one or both of the inputs of the next AND gate in the ring. Thus, a logic signal will travel through the gates at a rate determined by the propagation delay of each of the AND gates, as well as the length and nature of the conductors connecting the AND gates. This configuration results in an oscillating signal begin generated by each AND gate, with each of the oscillating signals being of a different phase. An output of each of the AND gates within a gated ring oscillator 110, 210 drives a separate vernier interpolator V0P-V3P, V0N-V3N. For example, AND gate X0P drives vernier interpolator V0P, and AND gate X0N drives vernier interpolator V0N. More specifically, when the output of an AND gate X0P-X3P, X0N-X3N becomes active, the operation of its associated vernier interpolator V0P-V3P, V0N-V3N, respectively, is initiated. After initiation, each vernier interpolator V0P-V3P, V0N-V3N operates for a period of time, during which an event arrival may be captured. The operation of the vernier interpolators V0P-V3P, V0N-V3N is described in further detail below. In alternative embodiments, a different number of AND gates (for example, three, five, six or another number) may be employed to similar end. Also, other logical gates, such as OR gates, NAND gates, NOR gates, and the like, may be employed in varying configurations to the same end. Generally, the higher the number of gates employed in the gated ring oscillators 110, 210, the higher the number of vernier interpolators required, thus allowing slower overall oscillations of the ring oscillators 110, 210 at the expense of more circuit area and higher power consumption. Conversely, fewer gates per ring oscillator 110 would reduce circuit area and power requirements, while requiring faster oscillation of the ring oscillators 110, 210, thus making capture of the event arrival time more problematic.

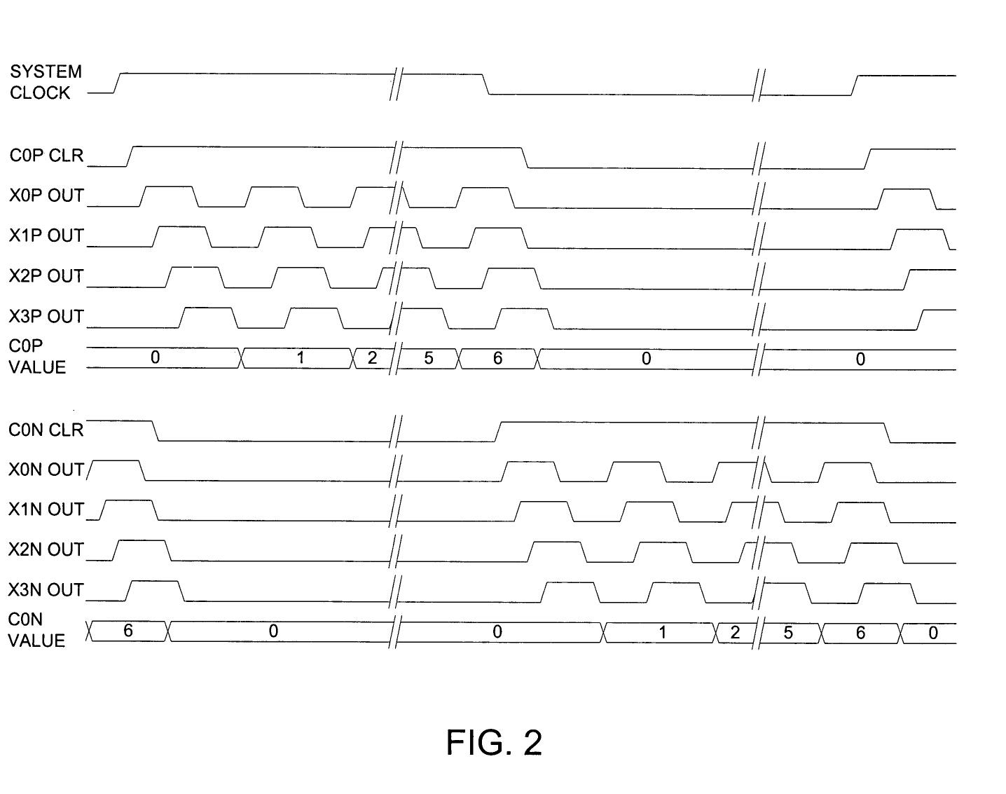

As shown in FIG. 1, each of the first three AND gates X0P-X2P, X0N-X2N in a phase section 100, 200 drives the succeeding AND gate with an active high output, while the last AND gate X3P, X3N drives the first AND gate X0P, X0N in the series with an active low output. Therefore, when a logic HIGH is introduced into the first AND gate X0P, X0N, the logic HIGH level is propagated through to the last AND gate X3P, X3N in the series, so that all AND gates of a gated ring oscillator 110, 210 represent a HIGH level at their outputs. Since the last AND gate X3P, X3N drives the first AND gate X0P, X0N with an active low output, the last AND gate X3P, X3N, upon being driven to a logic HIGH, drives the first AND gate X0P, X0N to a logic LOW, which propagates through all AND gates of the series until all are LOW. At that point, the last AND gate X3P, X3N drives the first AND gate X0P, X0N to a logic HIGH, beginning the process anew, resulting in an oscillation of the output of each AND gate X0P-X3P, X0N-X3N. The timing diagram of FIG. 2 exemplifies the operation of the gated ring oscillators 110, 210.

Each gated ring oscillator 110, 210 also employs a small “keep-alive” circuit 120, 220 to control the oscillation of its associated series of AND gates X0P-X3P, X0N-X3N making up the gated ring oscillator 110, 210. Each keep-alive circuit 120, 220 contains a D flip-flop 122, 222 and a logical OR gate 124, 224, both of which are driven by the system clock 2, as shown in FIG. 1. In an alternative embodiment, other types of logical storage elements, such as a J-K or S-R flip-flops, may be implemented in lieu of the D flip-flop 122, 222. Also, other gates or combinations of gates may be employed instead of an OR gate 124, 224.

The keep-alive circuits 120, 220 initiate the oscillation of the AND gates X0P-X3P, X0N-X3N when the associated phase section 100, 200 becomes active. For example, when the system clock 2 transitions from a logic LOW to a logic HIGH, one input of the OR gate 124 of the keep-alive circuit 120 within the positive phase section 100 is driven HIGH. The HIGH output drives one of the inputs of the first AND gate X0P HIGH, thereby initiating the oscillation of the positive phase section AND gates X0P-X3P, with all of the outputs of the AND gates X0P-X3P becoming HIGH in series. When the output of the last AND gate X3P transitions to the HIGH state, an active high output of the last AND gate X3P, connected to the clock input of the D flip-flop 122, latches the current value of the system clock 2 (i.e., HIGH), thus driving the second input of the OR gate 124 HIGH as well. Therefore, for proper operation of the circuit, the system clock 2 should have a frequency sufficiently low such that the particular phase of the system clock 2 is essentially constant while the system clock 2 propagates through the OR gate 124 and all four AND gates X0P-X3P, and latches the value of the system clock 2 into the D flip-flop 122. Otherwise, the gated ring oscillator 110 may not produce a full initial cycle, thus potentially causing timing anomalies within the vernier interpolators V0P-V3P driven by the AND gates X0P-X3P.

As long as the system clock 2 remains HIGH, the output of the OR gate 124 remains HIGH, thus ensuring the continued oscillation of the series of AND gates X0P-X3P in the positive phase section 100. Once the system clock 2 transitions from HIGH to LOW, the positive phase keep-alive circuit 120 ensures that the AND gates X0P-X3P complete their current oscillation. In other words, the AND gates X0P-X3P continue to operate as described above until the next time the active high output of the last AND gate X3P transitions from LOW to HIGH, thus latching the current value of the system clock 2 (i.e., LOW) into the D flip-flop 122. At that point, the output of both the D flip-flop 122 and the OR gate 124 of the keep-alive circuit 120 are LOW, thus forcing the output of the first AND gate X0P (and every other AND gate X1P-X3P in series) LOW, at which point the oscillation of the positive phase gated ring oscillator 110 ceases.

At the same time, the transition of the system clock from HIGH to LOW initiates the oscillation of the gated ring oscillator 210 of the negative phase section 200, which includes the negative phase keep-alive circuit 220, the negative phase counter CON, and the AND gates X0N-X3N. The D flip-flop 222 and the OR gate 224 of the negative phase keep-alive circuit 220, shown in FIG. 1, are responsive to the negative phase of the system clock 2, as illustrated by the inversion “bubbles” indicated at the inputs of the flip-flop 222 and the gate 224.

The gated ring oscillator 210 of the negative phase section 200 then operates as described above in relation to the positive phase oscillator 110. When the logic level of the system clock 2 returns HIGH, the negative phase keep-alive circuit 220 provides for the continued oscillation of the related gated ring oscillator 210 until the current oscillation is complete, as described above with respect to the positive phase section 100. The same LOW-to-HIGH transition of the system clock 2 also reinitiates oscillation of the positive phase section gated ring oscillator 110, restarting the entire oscillation process, which continues in this fashion as long as the system clock 2 continues to oscillate.

Associated with each gated ring oscillator 110, 210 is a phase counter C0P, C0N, which counts the number of oscillations made by the gated ring oscillator 110, 210 during a particular phase of the system clock 2. At the beginning of each phase of the system clock 2, the associated phase counter C0P, C0N is reset to zero by way of the output of the related keep-alive circuit 120, 220 being LOW. For example, after the system clock 2 goes from HIGH to LOW, ultimately causing the output of the positive phase keep-alive circuit 120 to transition LOW when the last positive phase oscillation is complete (as described above), the positive phase counter C0P is set to zero by way of its clear input.

Thereafter, when the system clock 2 returns to the HIGH logic state, the output of the positive phase keep-alive circuit 120 also goes HIGH, thus enabling the positive phase counter C0P by inactivating its clear input. While the system clock 2 remains HIGH, the value of the positive phase counter C0P is incremented each time the active low output of the last AND gate X3P transitions from LOW to HIGH (i.e., when a logic LOW propagates through the last AND gate X3P). In so doing, the value of the positive phase counter C0P denotes the number of the current oscillation of the gated ring oscillator 110 for the current phase of the system clock 2, thus providing a portion of the information that indicates when an event has occurred. The negative phase counter C0N operates in a corresponding manner. The timing diagram of FIG. 2 graphically illustrates the operation of the phase counters C0P, C0N. In one particular embodiment, the phase counter C0P, C0N may reach a maximum value of five or six before being reset due to a change of phase in the system clock 2. Other embodiments may involve a higher or lower maximum counter value, depending on the frequency of the system clock 2 and the amount of time required for one complete oscillation of each gated ring oscillator 110, 210.

The value of each phase counter C0P, C0N, as well as the current phase of the system clock 2 (HIGH or LOW) and the identity and stored state of the vernier interpolators V0P-V3P, V0N-V3N, are employed as part of the time code, or timestamp, generated by embodiments of the present invention, as described in greater detail below.

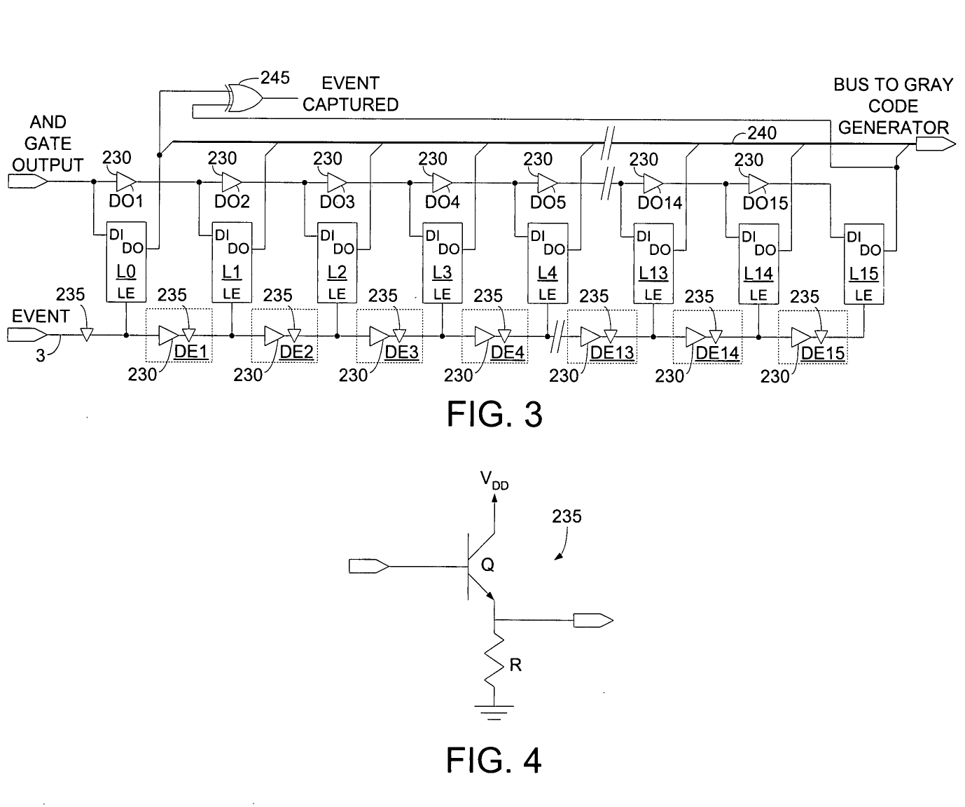

Each AND gate X0P-X3P, X0N-X3N of the gated ring oscillators 110, 210 drives corresponding vernier interpolator V0P-V3P, V0N-V3N, respectively, to finely determine the time of the arrival of an event indicated by the event signal 3. Each of the vernier interpolators V0P-V3P, V0N-V3N, shown in greater detail in FIG. 3, contains a series of latches Lo-L15 and signal delay elements DO1-DO15, DE1-DE15 to create paths of slightly different propagation delays for the output of the associated AND gates X0P-X3P, X0N-X3N and the event signal 3. More specifically, the output of the AND gates X0P-X3P, X0N-X3N driving the vernier interpolators V0P-V3P, V0N-V3N of interest, drive a series of fifteen signal buffers 230 acting as signal delay elements DO1-DO15. In this particular example, each buffer 230 exhibits a propagation delay of 16 picoseconds (psec). Each buffer 230 drives the data input of a separate data latch L1-L15. An extra data latch L0 is driven directly by the associated AND gate output X0P-X3P, X0N-X3N, for a total of sixteen latches L0-L15. In addition, each output of each data latch L0-L15 forms part of a bus 240 indicating a state of the vernier interpolators V0P-V3P, V0N-V3N, the state being reflected as a digital number denoting the arrival of an event. The bus 240 drives the input of a Gray code encoder 310 of the composite time coder 300, described below.

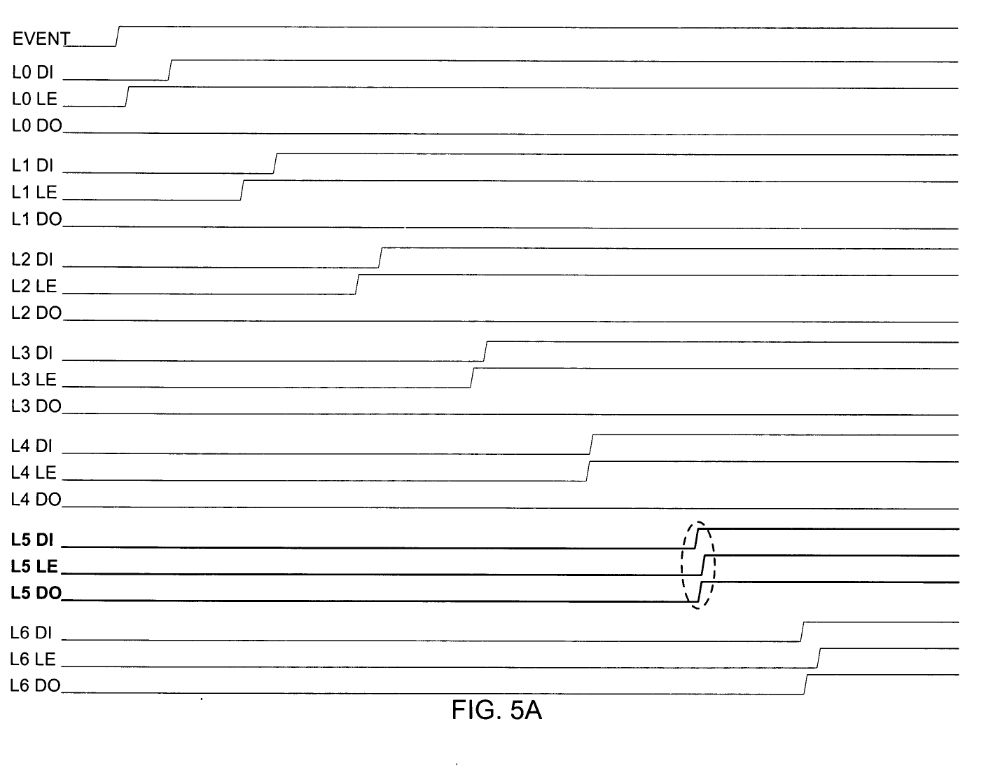

The event signal 3 drives each of the vernier interpolators V0P-V3P, V0N-V3N, propagating through a series of delay elements DE1-DE15 of slightly longer delay relative to the delay elements DO1-DO15 employed for the associated AND gate output. In the embodiment of FIG. 3, each event delay element DE1-15 is implemented by a buffer 230 (such as those employed for the AND gate X0P-X3P, X0N-X3N output), plus a fast emitter-follower circuit 235, such as that shown in FIG. 4. In the particular embodiment of FIG. 3, an additional delay prior to the first latch L0, constituting only a single emitter-follower circuit 235, is also employed. The emitter-follower circuit 235, including a single transistor and resistor in combination, exhibits a short propagation delay of about 1.5 psec, thus making the propagation delay of each delay element DE1-DE15 for the event signal 3 approximately 17.5 psec. This slight differential in delay of about 1.5 psec between the output of the associated AND gate X0P-X3P, X0N-X3N and the event signal 3 determines the theoretical resolution of the timestamp associated with an event arrival.

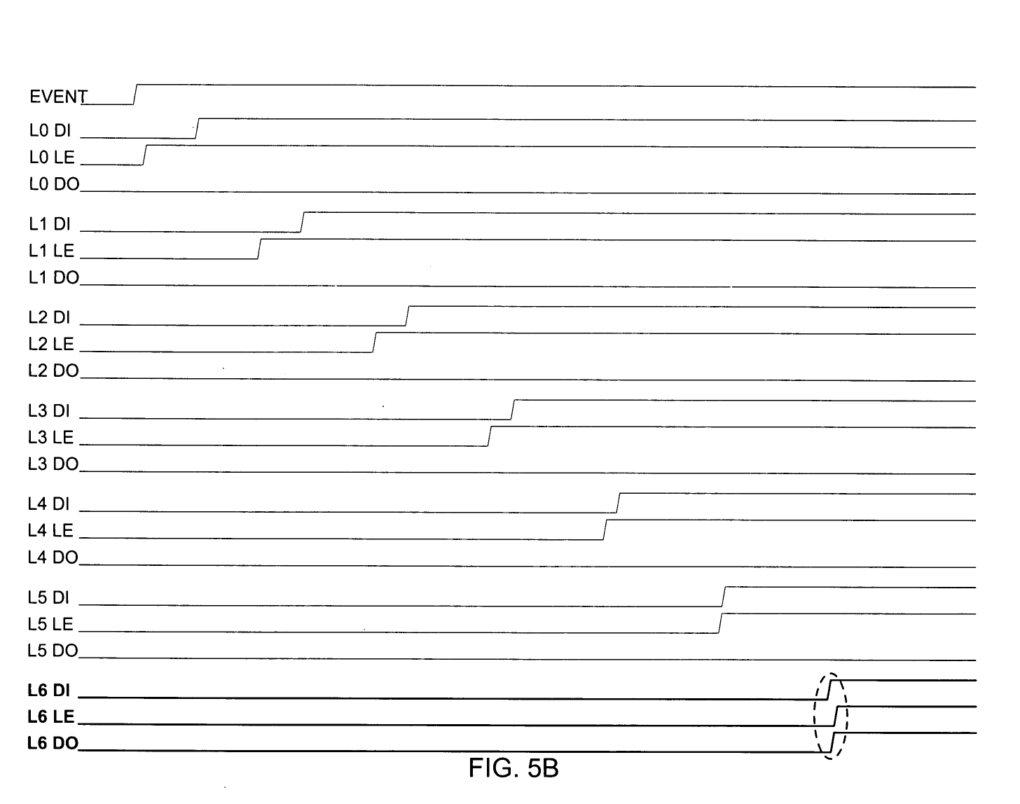

To more fully explain, FIGS. 5A and 5B present timing diagrams illustrating the operation of the first seven latches L0-L6 of the vernier interpolator V0P associated with the output of its driving AND gate X0P. For each latch L0-L7, the “data input” (“DI”), “latch enable” (“LE”) and “data output” (“DO”) signals are shown. For example, the latch enable signal for the first latch L0 is marked as L2 LE, while the data output signal for the second latch L1 is denoted L0 DO. Generally, the data out signal of a latch follows its data input signal while the latch enable signal is inactive. Once the latch enable signal becomes active, however, the data output signal is maintained at its current logical level until the latch enable signal is once again deactivated.

FIG. 5A represents the case of an event signal 3 reaching the input of the interpolator V0P 8 psec prior to the output of the AND gate X0P transitioning from LOW to HIGH. Assuming all other propagation delays are zero, and latch set-up times are negligible, the output of the AND gate X0P driving the interpolator V0P “catches up” with the event signal 3 at the latch L5 (i.e., the output of the AND gate X0P arrives at the data input DI of the latch L5 before the event signal 3 reaches the latch enable input LE of the latch L5) due to event signal 3 being delayed 1.5 psec longer per latch. Just prior to latch L5, the event signal 3 has thus been delayed 6×1.5(=9 psec) longer than the output of the AND gate X0P, thus making up for 8 psec lead initially enjoyed by the event signal 3. The signals associated with latch L5 are highlighted in the dashed oval of FIG. 5A. This scenario results in logic LOWs being stored in latches L0-L4, and logic HIGHs being captured into the latches L5-L15, thus producing a digital number of 0000011111111111 (in binary notation) of the interpolator V0P indicating the arrival time of the event in relation to the associated AND gate X0P output.

However, as shown in FIG. 5B, an event arriving just 1.5 psec earlier (thus leading the AND gate X0P output by 9.5 psec) results in the AND gate X0P output not being stored as a HIGH value until latch L6, the signals of which are illustrated in the dashed oval of FIG. 5B. At that point, the event signal 3 has been delayed 1.5×7, or 10.5, psec longer than the AND gate X0P output signal. The resulting digital value of the interpolator V0P in that case is 0000001111111111. Therefore, event arrivals differing by only 1.5 psec may be distinguished by the interpolator V0P. Table 1 displays the arrival times of the AND gate X0P output and event signal 3 for these two examples at each latch L0-L15, and the resulting latch values. All times shown in the table are referenced to the arrival of the event signal 3 at the input of the first emitter-follower circuit 235, which drives the latch enable input of the first latch L0.

TABLE 1
Signal Arrival Times for FIGS. 5A and 5B

| | Event | | Latch | | Latch |
|---|---|---|---|---|---|
| Latch | Arr. | AND Output | Value | AND Output | Value |
| No. | (psec) | (5A) (psec) | (FIG. 5A) | (5B) (psec) | (FIG. 5B) |
| L0 | 1.5 | 8 | LOW | 9.5 | LOW |
| L1 | 19 | 24 | LOW | 25.5 | LOW |
| L2 | 36.5 | 40 | LOW | 41.5 | LOW |
| L3 | 54 | 56 | LOW | 57.5 | LOW |
| L4 | 71.5 | 72 | LOW | 73.5 | LOW |
| L5 | 89 | 88 | HIGH | 89.5 | LOW |
| L6 | 106.5 | 104 | HIGH | 105.5 | HIGH |
| L7 | 124 | 120 | HIGH | 121.5 | HIGH |
| L8 | 141.5 | 136 | HIGH | 137.5 | HIGH |
| L9 | 159 | 152 | HIGH | 153.5 | HIGH |
| L10 | 176.5 | 168 | HIGH | 169.5 | HIGH |
| L11 | 194 | 184 | HIGH | 185.5 | HIGH |
| L12 | 211.5 | 200 | HIGH | 201.5 | HIGH |
| L13 | 229 | 216 | HIGH | 217.5 | HIGH |
| L14 | 246.5 | 232 | HIGH | 233.5 | HIGH |
| L15 | 264 | 248 | HIGH | 249.5 | HIGH |

The particular examples of Table 1 and FIGS. 5A and 5B show the example of the output of the associated AND gate X0P transitioning from LOW to HIGH. In other cases, the event signal 3 may become active at the time the output of the AND gate X0P output transitions from HIGH to LOW, in which case the first latches of the interpolator V0P will store a HIGH value, while the proceeding latches will store a LOW state.

The bus 240 formed by the outputs of each vernier interpolator V0P-V3P, V0N-V3N may then drive a Gray code generator 310 of the composite time coder 300, as indicated in FIG. 1. Gray codes are structured such that each increment of a value represented by a Gray code results in a change of just one bit of the Gray code. Such codes are typically used to prevent the capture of an incorrect value during a transition when two bits of the value must change for a single increment (e.g., when incrementing from three to four, or 011 to 100 in binary notation). Also, the use of Gray codes allows compression of the interpolator portion of the time code from sixteen bits to five bits, thus requiring less data storage. Table 2 shows the relationship between each potential value stored in the latches L0-L15 of an interpolator V0P-V3P, V0N-V3N (in hexadecimal notation), and its associated Gray code, according to one embodiment of the invention. Other Gray codes may be implemented in alternative embodiments. Other types of codes, or the raw data value of the latches L0-L15, may also be ultimately employed in the generated time code.

TABLE 2
Vernier Interpolator Gray Code Translations

| | Resulting | | Resulting |
|---|---|---|---|
| Interpolator Latch | Gray | Interpolator Latch | Gray |
| Value (rising edge) | Code | Value (falling edge) | Code |
| 0x0000 | 0x00 | 0xFFFF | 0x18 |
| 0x0001 | 0x01 | 0xFFFE | 0x19 |
| 0x0003 | 0x03 | 0xFFFC | 0x1B |
| 0x0007 | 0x02 | 0xFFF8 | 0x1A |
| 0x000F | 0x06 | 0xFFF0 | 0x1E |
| 0x001F | 0x07 | 0xFFE0 | 0x1F |
| 0x003F | 0x05 | 0xFFC0 | 0x1D |
| 0x007F | 0x04 | 0xFF80 | 0x1C |
| 0x00FF | 0x0C | 0xFF00 | 0x14 |
| 0x01FF | 0x0D | 0xFE00 | 0x15 |
| 0x03FF | 0x0F | 0xFC00 | 0x17 |
| 0x07FF | 0x0E | 0xF800 | 0x16 |
| 0x0FFF | 0x0A | 0xF000 | 0x12 |
| 0x1FFF | 0x0B | 0xE000 | 0x13 |
| 0x3FFF | 0x09 | 0xC000 | 0x11 |
| 0x7FFF | 0x08 | 0x8000 | 0x10 |

Variations in different digital logic technologies, IC manufacturing processes, circuit operating environments and the like can influence the performance, and hence the results, of the portions of the time code generator 1 described above. Such variations should be taken into account when analyzing the expected signal timing and resolution of the code time generator 1.

Although sixteen latches and a corresponding number of delay elements are implemented in the embodiment of FIG. 3, other numbers of latches and delay elements may be employed to similar end. Further, variations in the delay element configurations are also possible while remaining within the scope of the invention. For example, an extra buffer 230 may be located prior to the first latch L0 in the path of either the AND gate output, the event signal 3, or both. Also, fast circuits other than an emitter-follower 235 may be employed to generate the slight propagation delay differential which produces the fine time resolution obtainable by the time code generator 1. For example, a fast differential buffer may be employed in lieu of the emitter-follower 235 to produce a very short propagation delay. Also, a slightly slower buffer 230 may replace the buffer 230/emitter-follower 235 combination to generate the slightly slower buffer delays provided for the output of the AND gates X0P-X3P, X0N-X3N associated with the vernier interpolators V0P-V3P, V0N-V3N.

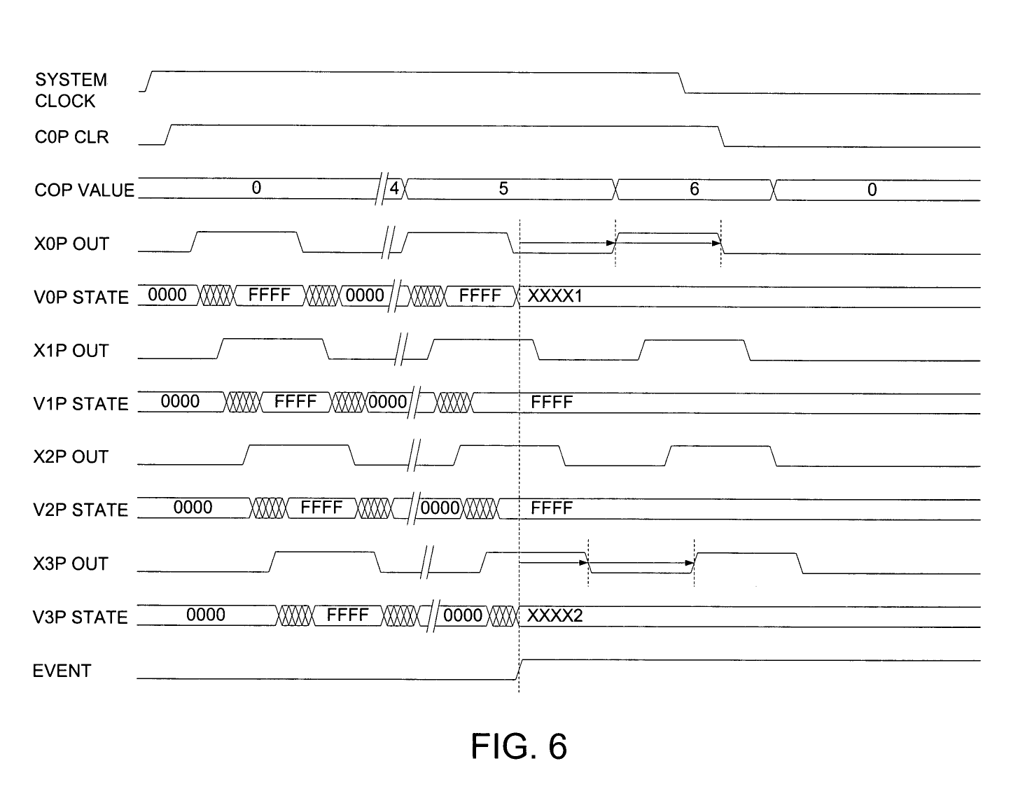

Referring again to FIG. 1, since each vernier interpolator V0P-V3P, V0N-V3N is driven by a separate AND gate X0P-X3P, X0N-X3N of the gated ring oscillators 110, 210, the AND gate output signal propagating through each interpolator V0P-V3P, V0N-V3N is initiated at a different point in time, or phase, as shown in the timing diagram of FIG. 6. Generally, the total propagation delay exhibited by an interpolator should be at least as long as the propagation delay associated with the driving AND gate and its connection to the next AND gate in the related ring, and less than twice that delay. Such a design ensures that at least one interpolator, and no more than two interpolators, will contain an event arrival, indicated by a transition within the latch L0-L15 states from LOW to HIGH or HIGH to LOW, as shown in Table 1, above. As a result, an event arriving at any point during a cycle of the system clock 2 will be successfully captured.

Since each interpolator V0P-V3P, V0N-V3N is initiated at a different point in a cycle of a gated ring oscillator 110, 210, the identity of the capturing interpolator, as well as the digital value of the state of that interpolator, is important in determining when the event occurred during a particular cycle of the associated gated ring oscillator. Whether an interpolator V0P-V3P, V0N-V3N contains an event arrival may be determined by comparing the stored values of the first latch L0 and last latch L15 of each interpolator. If they are the same (i.e., both LOW or both HIGH), the interpolator does not hold the event. If they are different (i.e., LOW and HIGH, or HIGH and LOW, depending on the transition direction of the related AND gate output), the interpolator has captured an event. Such a determination may be made with an exclusive-OR (XOR) gate 245 included with each interpolator, as shown in FIG. 3.

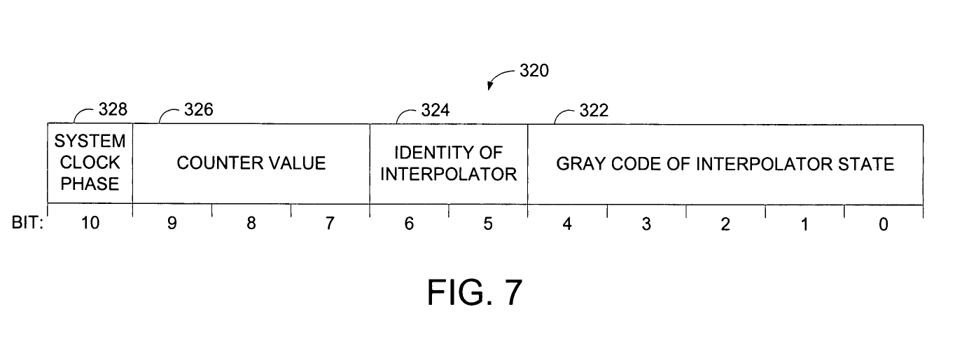

FIG. 7 depicts a complete composite time code, or timestamp 320, associated with the arrival of an event (i.e., the event signal 3 transitioning HIGH) during a particular cycle of the system clock 2. Beginning with the least significant bit fields, the timestamp 320 includes: (1) the Gray code 322 derived from the state or digital value of the latches L0-L15 of the selected vernier interpolator, as described above (five bits); (2) the identity 324 of the interpolator selected out of the four active interpolators V0P-V3P or V0N-V3N (two bits); (3) the value 326 of the active phase counter C0P, C0N associated with the selected interpolator (nominally three bits, presuming the value of the phase counter C0P, C0N cannot reach higher than seven in any phase of the system clock); and (4) the phase 328 (HIGH or LOW) of the system clock 2 associated with the interpolator (one bit), determined by the identity of the phase counter C0P, C0N being used at the particular time, which can be identified by way of the output of the associated keep-alive circuit 120, 220. In one embodiment, if the event occurs during the positive phase of the system clock 2, a zero occupies the most significant bit, while a one is used if the event is captured during the negative phase. These four sources of information 322, 324, 326, 328 thus provide a total of eleven bits for a timestamp 320 that indicates where within a particular period of the system clock 2 an event occurred. In an alternative embodiment, the number of bits of the timestamp may vary depending on, in part, the resolution of each vernier interpolator, the number of vernier interpolators, and the number of oscillations of a gated ring oscillator 110, 210 that may occur during a phase of the system clock 2.

As mentioned above, and as shown in FIG. 6, the possibility exists that two consecutive vernier interpolators may capture the same event arrival (for example V1P and V2P, or V3N and V0N). The probability of such a circumstance increases as the amount of overlap exhibited by the vernier interpolators increases. In the case two consecutive interpolators capture the same event arrival, the system may select either interpolator based on some predetermined priority, as either interpolator represents a valid time code for the event. In one embodiment, the earlier of the two interpolators may always be selected by way of a priority logic circuit. In that case, V1P would be selected over V2P, and V3N would be selected over V0N. In another embodiment, the latter of the two interpolators may be selected instead.

Given the above description regarding the vernier interpolators V0P-V3P, V0N-V3N, a valid interpolator Gray-encoded value, as well as the identity of the selected interpolator (together representing the lower seven bits of the timestamp 320), is captured, or “registered,” properly within the composite time coder 300 by way of the event signal 3. However, using the event signal 3 to register the arrival of the event introduces potential metastability or misregistration when the remaining four bits of the timestamp 320, which are synchronous with the system clock 2, are registered within the composite time coder 300. Metastability refers to the possible instability or oscillation of a data latch or register output when the associated data input arrives at essentially the same instant as the related clock or latch enable signal. Misregistration refers to the possibility of aligning an incoming data input of a latch or register with an incorrect period of a clock or latch enable signal. In other words, since the event signal 3 and the system clock 2 are not synchronous, metastability and misregistration with respect to the value of the phase counter C0P, C0N, or the identity of the phase of the system clock 2 during which the event arrived, is possible.

In one embodiment, metastability and misregistration of the value of the phase counter C0P, C0N is prevented, or significantly reduced, by employing within the composite time coder 300 a sequential logic circuit driven by each gated ring oscillator 110, 210. The sequential logic circuit delays registration of the value of the phase counter C0P, C0N until the second edge of the output of the AND gate X0P-X3P, X0N-X3N driving the selected interpolator V0P-V3P, V0N-V3N after the event arrival. The timing diagram of FIG. 6 illustrates the effect of the sequential logic circuit. An event arrival, shown by the rising edge of the event signal 3, is captured by two vernier interpolators, V3P and V0P, as indicated by their states not equaling all zeros (0000 in hexadecimal notation) or all ones (FFFF in hexadecimal notation). In the case V3P is the selected interpolator (with a state indicated by XXXX2), the value of the positive phase counter C0P is registered (i.e., clocked or latched into a register within the composite time coder 300) on the first rising edge after the first falling edge of the output of the AND gate X3P driving V3P. If, instead, V0P is the selected interpolator (having a state indicated by XXXX1), the positive phase counter C0P value is registered on the first falling edge after the first rising edge of the output of AND gate X0P.

Since each phase counter C0P, C0N is incremented upon the falling edge of the output of the related fourth AND gate X3P, X3N, the sequential logic circuit is designed so that events captured by way of the falling edge of the output of the last AND gate X3P, X3N of the gated ring oscillator 110, 210 cause the current phase counter C0P, C0N value to be registered prior to incrementing of the counter on the falling edge of the last AND gate X3P, X3N. This function may be accomplished by ensuring the clocking of the phase counter C0P, C0N occurs after registration of the value of the phase counter C0P, C0N relating to an event arrival. Further, since registration of the phase counter C0P, C0N may occur near the end of a positive or negative phase of the system clock 2, the clearing of the phase counter C0P, C0N that normally occurs by way of a change in phase of the system clock 2 is delayed until the value of the phase counter C0P, C0N associated with an event arrival has been registered. Such functionality substantially eliminates any metastability or misregistration involving registration of the value of the phase counter C0P, C0N.

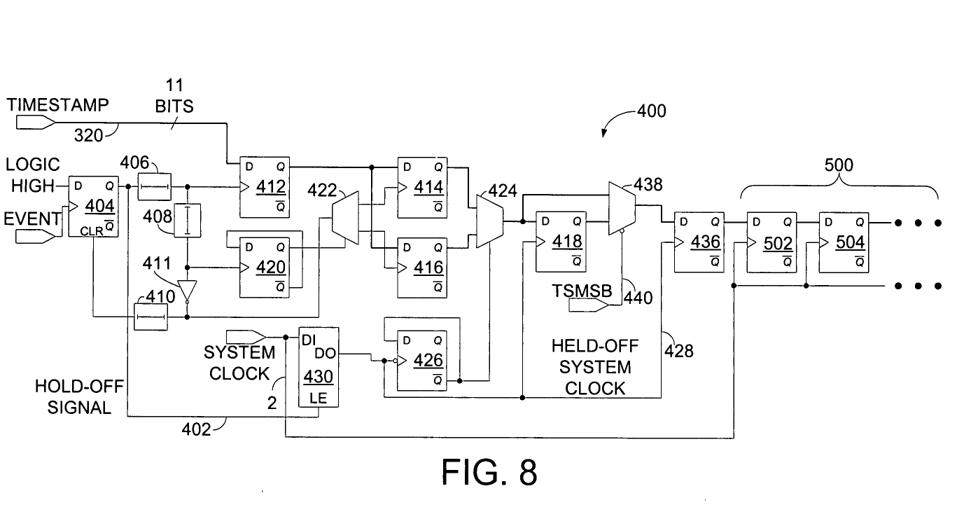

Using the various embodiments of the invention, one event arrival per cycle of the system clock 2 may be captured. In order to further identify each event arrival relative to the system clock domain, each captured event may be associated with the appropriate cycle of the system clock 2 during which the event arrived. However, given that the event signal 3 and the system clock 2 are not synchronous, misregistration or metastability involving registration of the timestamp 320 with the corresponding period of the system clock 2 during which the event arrives may be a concern. Referring to FIG. 8, while the timestamp 320 generated for a particular event indicates with a high degree of resolution where within a particular system clock 2 period an event occurred, the system incorporating the time code generator 1 attempts to retrieve a timestamp 320 from the time code generator 1 once per period of the system clock 2 so that the particular system clock period during which an event occurred may be identified. To this end, the system implements a FIFO (first in, first out) buffer 500 to collect one time code sample per system clock period, the first two storage elements 502, 504 of the FIFO buffer 500 being shown in FIG. 8. As a result, events should occur at most once per system clock if the system is to capture the time of each event. System clocks 2 during which no event has occurred are typically indicated by all zeros.

Metastability in transferring the generated timestamp 320 into the buffer may occur if the event arrives close to the rising edge of the system clock 2. Further, misregistration may occur if the timestamp 320 arrives too late to be clocked into the FIFO buffer 500 during the appropriate system clock cycle compared to other events previously clocked into the FIFO buffer 500, thus indicating the event occurred one cycle of the system clock 2 later than when it actually occurred.

To alleviate such a problem, a system clock domain synchronizing circuit 400 depicted in FIGS. 1 and 8 may be employed to properly register the generated timestamp 320 with the temporally correct period of the system clock 2. The synchronizing circuit 400 first initiates a “hold-off” signal 402 beginning at a propagation delay of a register 404 being clocked by the arrival of an event. Three signal delay elements 406, 408, 410, in addition to the propagation delay of the register 404, serve to extend the hold-off signal 402 for a duration exceeding the settling time of the input to a timestamp register 412 and the inputs of two ping-pong registers 414, 416. The value of the first delay element 406 is chosen so that the inputs to the timestamp register 412 are stable before the timestamp register 412 is clocked (in the case of FIG. 8, 240 psec). The second delay element 408 is selected such that the output of the timestamp register 412 is stable so that either of the ping-pong registers 414, 416 may be clocked via an inverter 411 (e.g., 40 psec in FIG. 8). Further, the third delay element 410 is set so that the outputs of the ping-pong registers 414, 416 provide the appropriate set-up time (e.g., 40 psec in FIG. 8) for a first FIFO register 418, which serves as one of two preliminary registers for the FIFO buffer 500. The output of the third delay element 410 resets the initial register 404, thus deactivating the hold-off signal 402 in preparation for the next event. In an alternative embodiment, the particular values chosen for the delay elements 406, 408, 410 may differ from those shown in FIG. 8, and would typically be selected in view of the particular logic family used, the particular gate lengths employed in the integrated circuit, and the like.

After the timestamp 320 has been captured in the timestamp register 412, the output of the second delay element 408 clocks one of the two ping-pong registers 414, 416 to hold the output of the timestamp register 412. The output of the second delay element 408 also drives a first switching register 420 whose output alternates between HIGH and LOW states for each event arrival, due to the feedback of the active-LOW output of the register 420 into the data input of the register 420. The output of the first switching register 420 drives a 1-to-2 demultiplexer 422, which causes the output of the second delay element 408 to alternately clock each of the ping-pong registers 414, 416 for successive events. The outputs of the ping-pong registers 414, 416 then drive a first 2-to-1 multiplexer 424. The output of one of the ping-pong registers 414, 416 is selected for input to the FIFO buffer 500 by way of a second switching register 426 whose output alternates between LOW and HIGH states by way of the falling edge of a held-off system clock 428, which essentially is the system clock 2 with a rising edge delayed by the presence of the hold-off signal 402 if the hold-off signal 402 precedes the system clock 2. The held-off system clock 428 is produced by way of a latch 430 whose latch enable is driven by the hold-off signal 402 and whose data input is driven by the system clock 2. As a result, the system clock 2 is held-off by the hold-off signal 402 only if the hold-off signal 402 reaches the latch 430 first.

The first and second FIFO registers 418, 436 prior to the FIFO buffer 500 are clocked by the same held-off system clock 428 so that the timestamp 320 is guaranteed to be present at the FIFO registers 418, 436 prior to either of the two FIFO registers 418, 436 being clocked. In other words, the system clock 2 is “held off” for a period of time if the event signal 3 occurs near the rising edge of the system clock 2 to prevent a metastable condition, which may cause incorrect data to be ultimately clocked into the FIFO buffer 500.

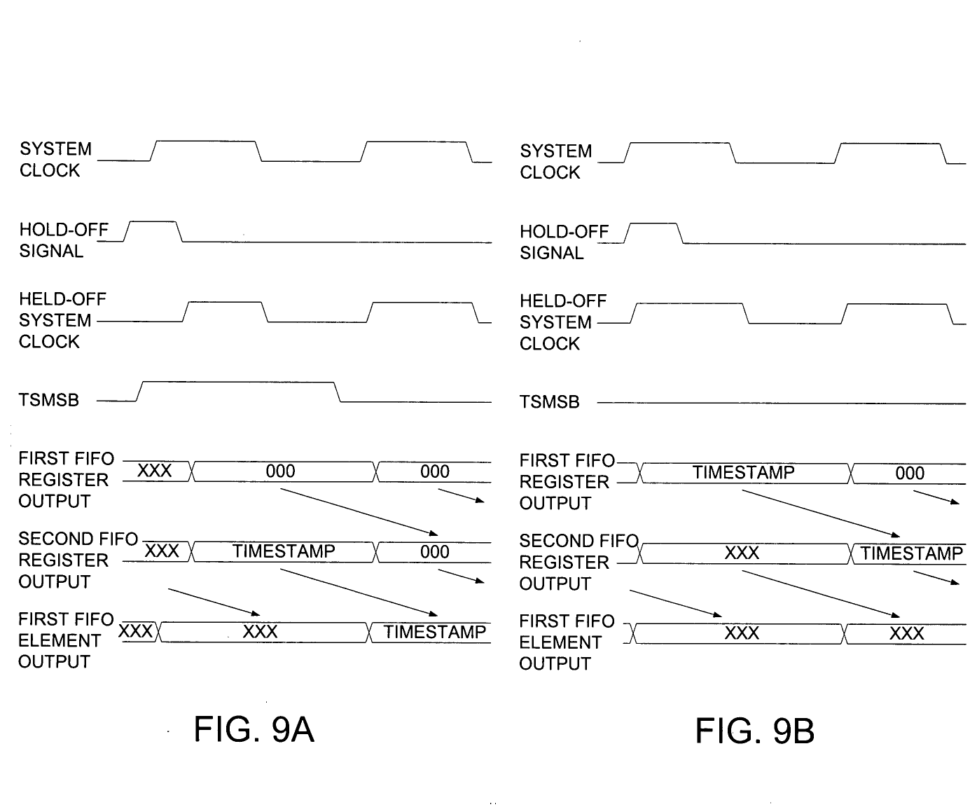

One possible consequence of holding off the system clock 2 is that a captured event may be clocked into the FIFO buffer 500 one system clock 2 too late. To eliminate that possibility, the synchronization circuit 400 of FIG. 8 is configured to allow a timestamp 320 to be stored in either of the two FIFO buffer registers 418, 436 by way of a second 2-to-1 multiplexer 438. Which of the two FIFO registers 418, 436 serves as the destination of the timestamp 320 depends on the most significant bit 440 of the timestamp 320, which indicates the phase of the system clock 2 in which the event arrived. If the most significant bit 440 is one (indicating the event occurred in the last half of the previous cycle), the timestamp 320 should be stored into the second FIFO register 436 to compensate for the timestamp 320 being latched one system clock 2 late. This scenario is represented in the timing diagram of FIG. 9A. —Otherwise, as shown in FIG. 9B, if the most significant bit 440 is zero (indicating the event occurred in the first (positive) half of the current cycle), the contents of the first FIFO buffer register 418 are clocked into the second register 436, and the contents of the selected ping-pong register 414, 416 is latched into the first FIFO buffer register 418. As a result, any possible misregistration of the timestamp 320 with respect to the system clock 2 is eliminated or substantially reduced.

Given the high-speed nature of the various embodiments of the time code generator disclosed herein, any of several fast logic families may be employed to construct the time code generator 1, including, but not limited to, emitter coupled logic (ECL), current mode logic (CML), or various high-speed versions of complementary metal oxide semiconductor (CMOS) logic.

Disclosed herein are several embodiments of circuits and methods for generating a digital value or timestamp indicating the time of the arrival of an event. As mentioned earlier, while these embodiments are described in specific terms, other embodiments encompassing principles of the invention are also possible. Thus, the scope of the invention is not to be limited to the disclosed embodiments, but is determined by the following claims.

We claim:

1. A time code generator for generating a digital value indicating an arrival time of an event, the time code generator comprising:
a first oscillator configured to generate a plurality of first oscillating signals during each positive phase of a system clock, wherein each of the plurality of first oscillating signals is of a different phase;
a first phase counter driven by one of the plurality of first oscillating signals;
a plurality of first vernier interpolators, each of the first vernier interpolators adapted to receive an event, and each of the plurality of first vernier interpolators is driven by one of the plurality of first oscillating signals;
a second oscillator configured to generate a plurality of second oscillating signals during each negative phase of the system clock, wherein each of the plurality of second oscillating signals is of a different phase;
a second phase counter driven by one of the plurality of second oscillating signals;
a plurality of second vernier interpolators, each of the second vernier interpolators adapted to receive the event, and each of the plurality of second vernier interpolators is driven by one of the plurality of second oscillating signals; and
a composite time coder configured to generate a digital value indicating an arrival time of an event, the composite time coder in communication with the first and second phase counters, the plurality of first vernier interpolators, and the plurality of second vernier interpolators, the composite time coder further adapted to receive the event.

2. The time code generator of claim 1, wherein one of either the first vernier interpolators or one of the second vernier interpolators captures the event.

3. The time code generator of claim 2, wherein the digital value comprises a digital number indicating a state of the vernier interpolator capturing the event.

4. The time code generator of claim 2, wherein the digital value comprises an identification of the vernier interpolator capturing the event.

5. The time code generator of claim 2, wherein the digital value comprises a value of the phase counter associated with the vernier interpolator capturing the event.

6. The time code generator of claim 2, wherein the digital value comprises an identification of the system clock phase associated with the vernier interpolator capturing the event.

7. The time code generator of claim 1, wherein:
the first phase counter is incremented by each oscillation of one of the plurality of first oscillating signals; and
the second phase counter is incremented by each oscillation of one of the plurality of second oscillating signals.

8. The time code generator of claim 2, the composite time coder comprising a Gray code generator for translating a state of the vernier interpolator capturing the event into a Gray code value.

9. The time code generator of claim 1, wherein the first oscillator comprises a first gated ring oscillator and the second oscillator comprises a second gated ring oscillator.

10. The time code generator of claim 9, wherein each of the first and second gated ring oscillators comprise:
a plurality of logical gates coupled together in a ring configuration, wherein each of the plurality of logical gates produces one of the plurality of oscillating signals generated by the gated ring oscillator; and
a keep-alive circuit configured to drive the plurality of logical gates to ensure that each of the plurality of oscillating signals driven complete its current oscillation.

11. The time code generator of claim 10, the plurality of logical gates comprising four logical AND gates.

12. The time code generator of claim 10, the keep-alive circuit comprising:
a logical storage element clocked by one of the plurality of logical gates, wherein a data input of the logical storage element is coupled with the system clock; and
a logical OR gate, the inputs of the OR gate being coupled with an output of the logical storage element and the system clock, the output of the OR gate driving one of the logical gates.

13. The time code generator of claim 12, the logical storage element comprising a D flip-flop.

14. The time code generator of claim 1, wherein each of the plurality of first vernier interpolators and each of the plurality of second vernier interpolators comprises:
a plurality of first signal delay elements coupled together in series, wherein each of the plurality of first signal delay elements provides a first signal delay, the first of the series of the plurality of first signal delay elements being driven by the oscillating signal driving the vernier interpolator;
a plurality of second signal delay elements coupled together in series, wherein each of the plurality of first signal delay elements provides a second signal delay longer than the first signal delay, the first of the series of the plurality of second signal delay elements being driven by the system clock; and
a plurality of data latches, wherein the data input of each of the plurality of data latches is driven by the output of one of the plurality of first signal delay elements, and wherein the latch enable of each of the plurality of data latches is driven by the output of one of the plurality of second signal delay elements, the outputs of the plurality of data latches being coupled with the composite time coder.

15. The time code generator of claim 14, wherein each of the plurality of first signal delay elements comprises a signal buffer.

16. The time code generator of claim 14, wherein each of the plurality of second signal delay elements comprises a signal buffer coupled in series with a signal delay circuit with a propagation delay of less than two picoseconds.

17. The time code generator of claim 16, the signal delay circuit comprising an emitter-follower circuit.

18. The time code generator of claim 14, the plurality of data latches comprising at least sixteen data latches.

19. The time code generator of claim 2, further comprising a sequential logic circuit operating to register a value of the phase counter associated with the vernier interpolator capturing the event, the registration occurring on the second edge of the oscillating signal driving the vernier interpolator capturing the event after the event arrival.

20. The time code generator of claim 1, further comprising:
a first-in, first-out (FIFO) buffer comprising a plurality of FIFO buffer elements, the FIFO buffer configured to accept the digital value from the composite time coder; and
a time domain synchronizer configured to transfer the digital value to the FIFO buffer during a temporally corresponding period of the system clock.

21. The time code generator of claim 20, the time domain synchronizer comprising:
a timestamp register configured to hold a plurality of digital values from the composite time coder in succession;
a first ping-pong register configured to receive the first, and every other thereafter, of the plurality of digital values from the timestamp register;
a second ping-pong register configured to receive the second, and every other thereafter, of the plurality of digital values from the timestamp register; and
a first and second FIFO registers configured to receive the plurality of digital values from the timestamp register via the first and second ping-pong registers;
wherein each of the plurality of digital values from the first and second ping-pong registers that is associated with an event that arrives late in a previous system clock cycle is clocked directly into the second FIFO register; and
wherein each of the plurality of digital values from the first and second ping-pong registers that is associated with an event that arrives early in a current system clock cycle is clocked directly into the first FIFO register.

22. The time code generator of claim 21, wherein the first and second FIFO registers are clocked by a version of the system clock in which a rising edge of the system clock is delayed so as to allow each of the plurality of digital values to be available for clocking into the first and second FIFO registers.

23. The time code generator of claim 21, wherein each of the FIFO buffer elements are clocked by the system clock.

24. The time code generator of claim 1, further comprising an automatic test equipment.

25. A time code generator for generating a digital value indicating an arrival time of an event, the time code generator comprising:
means for generating a plurality of oscillating signals by way of a system clock, wherein each of the plurality of oscillating signals oscillates faster than the system clock, and is initiated at a different phase within each period of the system clock;
means for capturing an event to produce a logical state indicating the time of the event relative to a particular oscillation of one of the plurality of oscillating signals; and
means for composing a digital value indicating the time of the event within a period of the system clock by way of the logical state from the capturing means, the identity of the one of the oscillating signals, and the identity of the particular oscillation of the one of the oscillation signals.

26. The time code generator of claim 25, wherein each of the plurality of oscillating signals is associated with one of a positive phase and a negative phase of the system clock.

27. The time code generator of claim 25, wherein the plurality of oscillating signals comprises four oscillating signals associated with a positive phase of the system clock, and four oscillating signals associated with a negative phase of the system clock.

28. The time code generator of claim 25, wherein the logical state from the capturing means is represented within the digital value as a Gray code value.

29. The time code generator of claim 25, wherein the capturing means comprises a vernier interpolator for each of the plurality of oscillating signals, wherein each vernier interpolator is configured to measure the arrival of the event relative to the oscillating signal associated with the vernier interpolator.

30. The time code generator of claim 25, further comprising means for synchronizing the digital value from the composing means with the system clock.

31. The time code generator of claim 25, further comprising means for testing an integrated circuit.

32. A method for generating a digital value indicating an arrival time of an event, comprising:
generating a plurality of oscillating signals by way of a system clock, wherein each of the plurality of oscillating signals oscillates faster than the system clock, and is initiated at a different phase within each period of the system clock;
capturing an event to produce a logical state indicating the time of the event relative to a particular oscillation of one of the plurality of oscillating signals; and
composing a digital value indicating the time of the event within a period of the system clock by way of the logical state from the capturing step, the identity of the one of the oscillating signals, and the identity of the particular oscillation of the one of the oscillation signals.

33. The method of claim 32, wherein each of the plurality of oscillating signals is associated with one of a positive phase and a negative phase of the system clock.

34. The method of claim 32, wherein the logical state from the capturing step is represented within the digital value as a Gray code value.

35. The method of claim 32, wherein the capturing step comprises measuring the arrival of the event relative to one of the oscillating signals.

36. The method of claim 32, further comprising synchronizing the digital value from the composing step with the system clock.

37. An automatic test equipment configured to perform the operations of claim 32.

38. A time domain synchronizer for transferring a digital value from a time code generator to a first-in, first-out FIFO buffer driven by a system clock, comprising:
a timestamp register configured to hold a plurality of digital values from the time code generator in succession;
a first ping-pong register configured to receive the first, and every other thereafter, of the plurality of digital values from the timestamp register;
a second ping-pong register configured to receive the second, and every other thereafter, of the plurality of digital value from the timestamp register; and
a first and second FIFO registers configured to receive the plurality of digital values from the timestamp register via the first and second ping-pong registers;
wherein each of the plurality of digital values from the first and second ping-pong registers that is associated with an event that arrives late in a previous system clock cycle is clocked directly into the second FIFO register; and
wherein each of the plurality of digital values from the first and second ping-pong registers that is associated with an event that arrives early in a current system clock cycle is clocked directly into the first FIFO register.

39. The time domain synchronizer of claim 38, wherein the first and second FIFO registers are clocked by a version of the system clock in which a rising edge of the system clock is delayed so as to allow each of the plurality of digital values to be available for clocking into the first and second FIFO registers.
